(19) United States
(12) Patent Application Publication
(10) Pub. No.: US 2024/0253265 A1
(43) Pub. Date: Aug. 1, 2024

(54) Fire Retardant Composition for Natural Fiber Products

(71) Applicant: Ecochem International NV, Olen (BE)

(72) Inventor: Pieter DAESELEIRE, Olen (BE)

(21) Appl. No.: 18/561,282

(22) PCT Filed: May 17, 2022
(86) PCT No.: PCT/EP2022/063349

§ 371 Date: Nov. 15, 2023

(30) Foreign Application Priority Data
May 17, 2021 (BE) BE2021/5394

(51) Int. Cl. B27K 3/36; B27K 3/16; B27K 3/32

(52) U.S. Cl. CPC B27K 3/36; B27K 3/163; B27K 3/32; B27K 2240/00

(57) ABSTRACT

The current invention relates to fire retardant composition for natural fiber products, in particular wood or wood-based panels, said fire retardant composition comprising one or more fire retardants and monoethanolamine, wherein said fire retardants have a total concentration of at least 20.00 wt. % based on the total weight of the fire retardant composition, and wherein monoethanolamine and said fire retardant are present in the fire retardant composition in a weight ratio of between 1:5 and 1:50. Further aspects of the invention relate to the use of the fire retardant composition, and to natural fiber products comprising said fire retardant composition.

### FIELD OF THE INVENTION

The present invention pertains to a fire retardant composition. In particular, the invention relates to a fire retardant composition for the manufacture or treatment of natural fiber products.

### BACKGROUND

Natural fiber products, more in particular wood and wood-based panels, are widely used in the construction business. These materials however have to meet extensive requirements regarding fire retarding and flame-proofing properties. In Europe, various standards and requirements are introduced which allow comparison of fire properties of construction materials (e.g. Euroclasse EN 13501-1). In order to meet these requirements and to meet the highest quality standards, natural fiber products are often supplemented with compositions with fire retarding properties. Possible treatments include addition of fire retardant compositions during the manufacturing process of these products, in particular wood or wood-based panels, addition to said products as a coating, through pressure treatment, or through atmospheric impregnation.

Treatment of natural fiber products with these various compositions however has some disadvantages. Particularly, it is often difficult to homogeneously distribute the compositions throughout the natural fiber products, wherein the treated product comprises certain areas which enjoy a better fire retardancy than others. As such, there exists a certain risk of introducing weak spots in the fire retarding properties provided to these natural fiber products. Therefore, often large amounts of fire retarding composition have to be applied to the natural fiber products in order to meet the requirements. Additionally, treatment of these natural fiber products commonly leads to a visible crystallization layer throughout or on the surface of said products, which does not meet the prerequisite high-quality standards, or in some cases even renders the treated product useless for further use in construction applications.

A fire retardant composition is known from WO 1991/000327, which can be used for treatment of wood and other cellulosic products, comprising a major amount of boric acid and a minor amount of a synergist material. In order to tackle solubilization issues of the composition, optionally, one or more solubilizers which increase the water solubility of boric acid are added. The synergist material herein mainly comprises hygroscopic fire retardants, for which the concentration is kept low in order to reduce crystallization effects. This however negatively influences the fire retarding properties of the composition.

US 2020/003910 describes a fire retardant composition for treatment of various wood products. The compositions comprise an aqueous solution of bisphosphonate selected from 1-hydroxyethane 1,1-diphosphonic acid, an alkanol amine, and optionally an alkaline agent.

U.S. Pat. No. 4,461,721 describes a wood preservative based on an aqueous mixture of boric acid and a water-soluble organic amine.

CN 102 941 607 describes a wood fire retardant comprising 10-35% parts of a phosphorus compound, 10-30% parts of boron type compounds, 10-40% parts of amino type compounds, 0.5-8% parts of surface-active agent and water.

U.S. Pat. No. 5,182,049 discloses an intumescence medium which contains an intumescence effective amount of at least one ammonium or amine salt of an acid phosphate of a metal of the 2nd or 3rd group of the periodic system of the elements, for example aluminum phosphate.

U.S. Pat. No. 4,145,296 describes a fire retardant ammonium salt composition which is stabilized against gelation by the addition of a gelling inhibitor. The composition described herein mainly has the purpose of retarding forest and rangeland fires. The composition is however not suited for the treatment of wood-based panels as treatment thereof would require large amounts of the composition in order to meet the required standards.

Accordingly, there remains a need in the art for a fire retardant composition which is suited for the manufacture or treatment of natural fiber products, in particular of wood or wood-based panels, which is highly effective and thus requires a low amount to be applied, and which can be homogeneously distributed without invoking the unwanted effect of crystallization.

The present invention aims to resolve at least some of the problems and disadvantages mentioned above.

### SUMMARY OF THE INVENTION

The present invention and embodiments thereof serve to provide a solution to one or more of above-mentioned disadvantages. To this end, the present invention relates to a fire retardant composition for natural fiber products, in particular wood or wood-based panels, according to claim 1.

Preferred embodiments of fire retardant composition are described in claims 2 to 12.

Further aspects of the invention relate to the use of the fire retardant composition for the manufacture or treatment of natural fibers, in particular wood or wood-based panels, according to claims 13 to 16, as well as to natural fiber products as such, following claims 17 and 18.

### DETAILED DESCRIPTION OF THE INVENTION

The present invention concerns a fire retardant composition for natural fiber products, in particular wood or wood-based panels.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight”, “weight percent”, “%. wt” or “wt. %”, here and throughout the description unless otherwise defined, refers to the relative weight of the respective component based on the overall weight of the formulation.

In a first aspect, the present invention relates to a fire retardant composition for natural fiber products, in particular for wood or wood-based panels, said fire retardant composition comprising one or more fire retardants and monoethanolamine, wherein said fire retardants have a total concentration of at least 20.00 wt. % based on the total weight of the fire retardant composition. Following the invention, monoethanolamine and said fire retardants are present in the fire retardant composition in a weight ratio of between 1:5 and 1:50.

The term “natural fiber products” herein refers to a broad group of products, among others to wood, timber, veneer, wood-based panels, or other fiber-based products. In particular, the term “wood” refers to the porous and fibrous structural tissue found in the stems and roots of trees and other woody plants. It is an organic material, a natural composite of cellulose fibers that are strong in tension and embedded in a matrix of lignin that resists compression. Wood planks and beams are important construction materials and commonly go by the name of lumber or timber. Wood can also be further processed to yield so-called “engineered” wood products. These products include plywood, densified wood, a medium-density fiberboard (MDF), a high-density fiberboard (HDF), a particle board (PB), an oriented strand board (OSB), laminated timber, parallel strand lumber (PSL), laminated strand lumber (LSL), oriented strand lumber (OSL), glued laminated timber (glulam) and laminated veneer lumber (LVL). Wood can alternatively be chemically treated, e.g. acetylated wood. In light of the present invention, the composition as described herein can more generally be applied to all wood- and cellulose-based materials that are to be employed in the production of furniture and in interior building construction. As such, these materials also extend to paper, natural fiber based insulation materials etc.

Typically, engineered wood products are made from the same hardwoods and softwoods used to manufacture lumber. Sawmill scraps and other wood waste can be used for engineered wood composed of wood particles or fibers, but whole logs are usually used for veneers, such as plywood, medium density fiberboard (MDF) or particle board. Some engineered wood products, like oriented strand board (OSB), can use trees from the poplar family, a common but non-structural species. Alternatively, it is also possible to manufacture similar engineered products from other cellulosic sources such as rye straw, wheat straw, rice straw, hemp stalks, kenaf stalks, or sugar cane residue, in which case they contain no actual wood but rather vegetable fibers. The possibility thus exist to use the fire retardant composition of the present invention for these alternative engineered products as well.

The term “fire retardant” relates to a compound which has the ability to slow down or stop the spread of fire or reduce its intensity. This is commonly accomplished by chemical reactions that reduce the flammability of fuels or delay their combustion. Fire retardants may also cool the fuel through physical action or endothermic chemical reactions.

The fire retardant composition according to the present invention intentionally combines fire retardants with monoethanolamine, which results in a composition with reduced crystallization upon manufacture or treatment of the substrates. The weight ratio of monoethanolamine to fire retardant herein is specifically chosen within the range of between 1:5 and 1:50 as this provides for optimal fire retardancy and simple application on a substrate, showing a vastly reduced crystallization effect.

Use of the expressions “crystallization” and “blooming” throughout the description relates to the process by which a solid is formed out of a liquid. Formation of said solid on the surface of, or in the internal structure of, a substrate is highly unwanted as this vastly reduces the efficacy of the fire retardant, i.e. as the composition is not homogeneously distributed in the substrate and therefore is not allowed to provide for a fire retardant effect over the entire substrate. As such, weaker spots exist, exhibiting a lower fire retardancy than is to be expected, which forms a substantial fire hazard. The term “blooming” generally refers to the visual appearance of crystallization, wherein a layer of crystallized solids on a surface is visible. Not only is such a layer generally perceived as unaesthetic, it furthermore hinders further processing of the treated products, e.g. through painting, varnishing or lacquering.

In light of the present invention, the fire retardant composition can be either a aqueous solution, an aqueous suspension, or an aqueous dispersion. Either way, monoethanolamine has the beneficial effect of improving solubility or dispersibility of the fire retardants, and optionally other components, in the composition. Additionally, the specific combination of fire retardants and monoethanolamine as described herein leads to a decrease in the viscosity of the aqueous fire-retardant composition, thus allowing a more homogeneous application of the fire retardant composition throughout a substrate and significantly reducing crystallization effects. Furthermore, monoethanolamine acts as a wetting agent, wherein the fire retardant composition is enabled to better penetrate the natural fibers of the treated product. As a result, lower amounts of fire retardant composition can be used in order to achieve a satisfactory fire retardancy in the resulting product, e.g. the wood-based panel.

In an embodiment, said fire retardants are chosen from a group excluding monoethanolamine.

According to a further or another embodiment, said fire retardants are chosen from the group of phosphorous-based compounds, sulfur-based compounds, boron-based compounds, ammonium-based compounds, guanidine-based compounds, citric acid based compounds, mineral hydroxides, or combinations thereof.

In an embodiment, the boron-based compound is an organic borate such as monoethanolamine borate, trimethyl borate or triethyl borate.

In an embodiment, said fire retardants are chosen from the group of monoethanolamine borate, trimethyl borate or triethyl borate, diammonium phosphate, diguanidine phosphate, guanidine sulfamate, magnesium ammonium phosphate, monoammonium phosphate, monoguanidine phosphate, phosphoric acid, potassium citrate, sodium tripolyphosphate, urea phosphate, or combinations thereof.

According to a further or another embodiment, said fire retardants comprise first fire retardants chosen from the group of aluminium trihydrate, ammonium bromide, ammonium chloride, ammonium polyphosphate, ammonium sulfamate, ammonium sulfate, borax pentahydrate, boric acid, citric acid, diammonium phosphate, diguanidine phosphate, disodium octaborate, guanidine sulfamate, magnesium ammonium phosphate, monoammonium phosphate, monoguanidine phosphate, phosphoric acid, potassium citrate, sodium tripolyphosphate, urea phosphate, zinc borate, or combinations thereof.

According to a further or another embodiment, said monoethanolamine and said first fire retardant are present in the fire retardant composition in a weight ratio of between 1:5 and 1:40. Within the specified weight ratio, crystallization is further reduced thus improving the homogeneous fire retarding effect of the composition on a treated substrate. Furthermore, even small traces of blooming are absent, thus providing substrates treated with the fire retardant composition of the invention with a more pleasing visual appearance, which is a solid advantage in construction applications. To add thereto, further processing of the treated substrates is possible, e.g. through painting, varnishing or lacquering, wherein adhesion of the paint, varnish or lacquer is optimally achieved on the surface of the substrate.

In some embodiments, said monoethanolamine and said first fire retardant are present in the fire retardant composition in a weight ratio of between 1:10 and 1:40, of between 1:15 and 1:40, of between 1:20 and 1:40, of between 1:25 and 1:40, or of between 1:30 and 1:40. In some embodiments, said monoethanolamine and said first fire retardant are present in the fire retardant composition in a weight ratio of between 1:5 and 1:35, of between 1:5 and 1:30, of between 1:5 and 1:25, or of between 1:5 and 1:20.

According to a further or another embodiment, said first fire retardants have a total concentration of between 20.00 and 75.00 wt. % based on the total weight of the fire retardant composition. By preference, said first fire retardants have a total concentration of between 25.00 and 75.00 wt. %, of between 30.00 and 75.00 wt. %, of between 35.00 and 75.00 wt. %, of between 40.00 and 75.00 wt. %, or of between 40.00 and 70.00 wt. % based on the total weight of the fire retardant composition.

According to a further or another embodiment, said monoethanolamine has a concentration of between 0.05 and 8.50 wt. % based on the total weight of the fire retardant composition. The amount of monoethanolamine is found to optimally fulfil its function of reducing crystallization of the fire retardant composition within the herein specified concentration range, meanwhile allowing the fire retardant composition to comprise an abundant amount of fire retardants. The composition is therefore optimally active, even for low application amounts. Optimal fire retarding properties are conferred to the treated substrates, wherein the fire retarding composition is homogeneously distributed and does not show any signs of crystallization or other irregularities in the product. The monoethanolamine herein acts as a crystallization inhibitor, allows to lower the viscosity of the fire retardant composition, and acts as a wetting agent, thereby improving penetration of the fire retardant composition in the treated substrate.

By preference, said monoethanolamine has a concentration of between 0.05 and 8.00 wt. %, of between 0.05 and 7.50 wt. %, of between 0.05 and 7.00 wt. %, of between 0.05 and 6.50 wt. %, of between 0.05 and 6.00 wt. %, of between 0.05 and 5.50 wt. %, or of between 0.05 and 5.00 wt. % based on the total weight of the fire retardant composition. More by preference, said monoethanolamine has a concentration of between 0.10 and 5.00 wt. %, more by preference of between 0.20 and 5.00 wt. %, of between 0.30 and 5.00 wt. %, of between 0.40 and 5.00 wt. %, or of between 0.50 and 5.00 wt. % based on the total weight of the fire retardant composition. Even more by preference, said monoethanolamine has a concentration of between 1.00 and 5.00 wt. %, of between 1.50 and 5.00 wt. %, of between 2.00 and 5.00 wt. %, of between 2.50 and 4.50 wt. %, or of between 3.00 and 4.00 wt. % based on the total weight of the fire retardant composition.

According to first preferred embodiment, said first fire retardants are chosen from the group of ammonium polyphosphate, diammonium phosphate, diguanidine phosphate, monoammonium phosphate, monoguanidine phosphate, phosphoric acid, sodium tripolyphosphate, urea phosphate, or combinations thereof, wherein said first fire retardants have a total concentration of between 20.00 and 75.00 wt. % based on the total weight of the fire retardant composition. Phosphorous based fire retardants show optimal compatibility with monoethanolamine, which allows high concentrations of phosphorous based fire retardant in the composition without the occurrence of crystallization. Hence, due to a homogeneous fire retardancy effect throughout a treated substrate, lower amounts of the fire retardant composition can be applied.

By preference, the concentration of ammonium polyphosphate, diammonium phosphate, diguanidine phosphate, monoammonium phosphate, monoguanidine phosphate, phosphoric acid, sodium tripolyphosphate, urea phosphate, or combinations thereof, is comprised between 25.00 and 75.00 wt. %, of between 30.00 and 75.00 wt. %, of between 35.00 and 75.00 wt. %, of between 40.00 and 75.00 wt. %, or of between 40.00 and 70.00 wt. % based on the total weight of the fire retardant composition.

In a further embodiment, said composition comprises one or more further fire retardants, wherein said further fire retardants are chosen from the group of borax pentahydrate, boric acid, disodium octaborate, zinc borate, or combinations thereof, and wherein said further fire retardants have a total concentration of between 2.50 and 10.00 wt. % based on the total weight of the fire retardant composition.

“Boric acid” and “sodium tetraborate” or “sodium tetraborate pentahydrate”, also known as “borax pentahydrate”, are frequently used in providing fire retardant properties to substrates. Boric compounds generally function as a flame retardant in both the condensed and vapor phases. Boric compounds are especially useful in combination with natural fiber products, in particular with wood or wood-based products, as boron also reacts with the cellulosic polymer available in said products. Upon exposure of the boric compound to a flame, the boron and hydroxyl groups of the cellulosic polymer form a glassy ester that coats the substrate and reduces polymer degradation. Therefore, the addition of boric compounds to the present composition can further enhance the fire retardant properties thereof. No crystallization of the fire retardant agents in the present composition occurs, allowing a homogeneous distribution on and throughout the natural fibers, in particular the wood or wood-based panels, and additionally allowing further processing thereof.

According to a further or another embodiment, boric acid and borax pentahydrate are present in the fire retardant composition in a weight ratio of between 1:5 and 5:1. The specific combination of both (i) boric acid and (ii) borax pentahydrate within the herein defined ratios allowed to further optimize the fire retardant properties of the present composition.

By preference, said boric acid and said borax pentahydrate are present in the fire retardant composition in a weight ratio of between 1:4 and 4:1, of between 1:3 and 3:1, of between 10:20 and 20:10, of between 11:20 and 20:11, of between 12:20 and 20:12, of between 13:20 and 20:13, or of between 14:20 and 20:14. More by preference, said boric acid and said borax pentahydrate are present in the fire retardant composition in a weight ratio of between 15:20 and 20:15, of between 16:20 and 20:16, of between 17:20 and 20:17, of between 18:20 and 20:18, or of between 19:20 and 20:19. Most by preference, said boric acid and borax pentahydrate are present in the fire retardant composition in a weight ratio of 1:1.

According to a second preferred embodiment, said first fire retardants are chosen from the group of borax pentahydrate, boric acid, disodium octaborate, zinc borate, or combinations thereof, wherein said first fire retardants have a total concentration of between 15.00 and 55.00 wt. % based on the total weight of the fire retardant composition. Boron-based fire retardants are optimally compatible with monoethanolamine, which allow improved solubilization and thus improves homogeneous distribution of the fire retardant composition throughout natural fiber products, in particular wood or wood-based panels, thus reducing the amount of crystallization. More by preference, said first fire retardants have a total concentration of between 15.00 and 50.00 wt. %, of between 15.00 and 45.00 wt. %, or of between 15.00 and 40.00 wt. % based on the total weight of the fire retardant composition.

The fire retardant composition has according to some embodiments a dry weight of between 10.0 and 75.0%. The dry weight as specified herein, refers to the amount of solids in the fire retardant composition. Herein, it is to be understood that the fire retardant composition is an aqueous solution. Within the specified dry weight ranges, the fire retardant composition is easy to handle as a liquid, easy to apply to a substrate, and can be homogeneously distributed without showing signs of crystallization or blooming. By preference, the fire retardant composition has a dry weight of between 20.0 and 70.0%.

According to a further or another embodiment, said fire retardant composition comprises one or more first fire retardants and monoethanolamine, wherein monoethanolamine and said first fire retardants are present in the fire retardant composition in a weight ratio of between 1:5 and 1:50, wherein said first fire retardants are chosen from the group of ammonium polyphosphate, diammonium phosphate, diguanidine phosphate, monoammonium phosphate, monoguanidine phosphate, phosphoric acid, sodium tripolyphosphate, urea phosphate, magnesium ammonium phosphate, or combinations thereof, wherein said first fire retardants have a total concentration of between 20.00 and 75.00 wt. % based on the total weight of the fire retardant composition and wherein said composition comprises one or more further fire retardants, wherein said further fire retardants are chosen from the group of borax pentahydrate, boric acid, disodium octaborate, zinc borate, or combinations thereof, and wherein said further fire retardants have a total concentration of between 2.50 and 10.00 wt. % based on the total weight of the fire retardant composition. Said one or more first fire retardants are not monoethanolamine.

According to a further or another embodiment, said first fire retardants are chosen from the group of diammonium phosphate, monoammonium phosphate, urea phosphate, magnesium ammonium phosphate, or combinations thereof, wherein said first fire retardants have a total concentration of between 20.00 and 75.00 wt. % based on the total weight of the fire retardant composition.

According to a further or another embodiment, said fire retardant composition comprises one or more first fire retardants and monoethanolamine, wherein monoethanolamine and said first fire retardants are present in the fire retardant composition in a weight ratio of between 1:5 and 1:50, wherein said first fire retardants are chosen from the group of phosphorous-based compounds, boron-based compounds, or combinations thereof, wherein said first fire retardants have a total concentration of between 20.00 and 75.00 wt. % based on the total weight of the fire retardant composition.

In an embodiment, the fire retardant composition for natural fiber products, comprises one or more first fire retardants and monoethanolamine, wherein said first fire retardants have a total concentration of between 20.00 and 75.00 wt. % based on the total weight of the fire retardant composition, wherein monoethanolamine and said first fire retardants are present in the fire retardant composition in a weight ratio of between 1:5 and 1:50, wherein said first fire retardants are chosen from the group of phosphorous-based compounds, boron-based compounds, ammonium-based compounds, or combinations thereof and wherein said composition comprises one or more further fire retardants, wherein said further fire retardants is borax pentahydrate and wherein said further fire retardants have a total concentration of between 2.50 and 10.00 wt. % based on the total weight of the fire retardant composition.

In an embodiment, said further fire retardants is borax pentahydrate and said first fire retardants are chosen from the group of diammonium phosphate, monoammonium phosphate, phosphoric acid, or combinations thereof.

In an embodiment, said fire retardant composition comprises:
2.0 to 4.0 wt. % monoethanolamine based on the total weight of the fire retardant composition;
2.5 to 4.0 wt. % borax pentahydrate based on the total weight of the fire retardant composition;
35.0 to 70.0 wt. % monoammonium phosphate based on the total weight of the fire retardant composition; and
20.0 to 35.0 wt. % water based on the total weight of the fire retardant composition.

In an embodiment, said fire retardant composition comprises:
2.0-4.0 wt. % monoethanolamine based on the total weight of the fire retardant composition;
2.5-4.0 wt. % borax pentahydrate based on the total weight of the fire retardant composition;
2.5-4.0 wt. % of a boron-based compound, for example an organic borate such as monoethanolamine borate or triethyl borate based on the total weight of the fire retardant composition;
35.0-70.0 wt. % monoammonium phosphate based on the total weight of the fire retardant composition; and
20.0-35.0 wt. % water based on the total weight of the fire retardant composition.

In another or further embodiment, said composition comprises monoethanolamine, a first fire retardant other than monoethanolamine, a further fire retardant other than monoethanolamine or the first fire retardant and solvents such as water.

A second aspect of the present invention relates to a use of the fire retardant composition according to any of the earlier embodiments for manufacturing wood-based panels, wherein said fire retardant composition is applied to cellulose containing material during the production process of the wood-based panel, preferably prior to said cellulose containing material being pressed to a panel in the presence of a resin. It is a particular advantage of the present invention that fire retardancy, homogeneous distribution and the absence of crystallization and blooming are achieved by applying a limited amount of fire retardant composition to cellulose containing material. The specific combination of fire retardants and monoethanolamine as described herein allows to inhibit crystallization, to lower viscosity of the composition and to improve wetting, i.e. penetration of the fire retardant composition throughout the wood-based panel.

A third aspect of the invention relates to a use of the fire retardant composition according to any of the earlier embodiments for the fire resistant treatment of natural fiber products, in particular of wood or wood-based panels, wherein said fire retardant composition is applied to said products by atmospheric or pressure impregnation. It is a particular advantage of the invention that, through combining fire retardants and monoethanolamine as described, penetration of the fire retardant composition in the products can be improved. Monoethanolamine herein acts as a wetting agent, which allows the composition to penetrate the fibers of the natural fiber products, thus ensuring a homogeneous distribution of the fire retardant composition throughout the product. Pressure impregnation is thus a highly efficient way of providing fire retardant properties to natural fiber products, in particular to wood or wood-based panels, after their manufacture.

A fourth aspect of the invention relates to a surface treatment of substrates, more in particular it relates to a use of the fire retardant composition according to any of the earlier embodiments for the fire resistant treatment of natural fiber products, in particular to wood or wood-based panels, wherein said fire retardant composition is applied as a coating to the surface of said natural fiber products. It is a particular advantage of the invention that, through combining fire retardants and monoethanolamine as described, crystallization of the composition on the treated surface is inhibited, thereby resulting in a substrate that is optimally fire retardant, is esthetically pleasing, and allows the application of finishing layers, i.e. painting, lacquering or varnishing. Monoethanolamine herein acts as a crystallization inhibitor, which allows for an optimally applied surface coating.

A fifth aspect of the invention relates to use of the fire retardant composition for the fire resistant treatment of natural fiber products, in particular wood or wood-based panels, wherein said fire retardant composition is applied to said natural fiber products by spraying or dipping.

A sixth aspect of the present invention concerns a fire retardant natural fiber product, in particular wood or a wood-based panel, comprising a fire retardant composition according to any one of the earlier embodiments.

By preference, said natural fiber product is a wood-based panel, chosen from plywood, densified wood, a medium-density fiberboard (MDF), a high-density fiberboard (HDF), a particle board (PB), an oriented strand board (OSB), laminated timber, parallel strand lumber (PSL), laminated strand lumber (LSL), oriented strand lumber (OSL), glued laminated timber (glulam), laminated veneer lumber (LVL), or combinations thereof.

The fire retardant wood-based panels as herein described show optimal fire retardant properties, and show no signs of crystallization or blooming, which renders them very well suited for use in construction, and furthermore allows further processing by means of painting, lacquering or varnishing. The fire retardants are homogeneously distributed on the surface of, or throughout, the wood-based panels.

### EXAMPLES

The invention is further described by the following examples which illustrate the invention, and are not intended to, nor should they be interpreted to, limit the scope of the invention.

### Example 1—Fire Retardant Composition Comprising MAP, DAP and Ammonium Polyphosphate

A fire retardant composition according to the present invention comprising MAP, DAP and ammonium polyphosphate is given in Table 1 below. The composition is an aqueous dispersion which can be added during production of fiber based products, in particular of wood or wood-based panels.

TABLE 1

| component | concentration (wt. %) |
|---|---|
| monoammonium phosphate (MAP) | 18.00 |
| diammonium phosphate (DAP) | 18.00 |
| ammonium polyphosphate | 10.00 |
| diguanidine phosphate | 3.00 |
| boric acid | 1.20 |
| borax pentahydrate | 1.20 |
| disodium octaborate | 1.20 |
| monoethanolamine (MEA) | 2.50 |
| dispersing agent | 0.20 |
| water | 46.90 |

The composition has excellent fire retarding properties and is suitable for manufacture and treatment of wood-based panels. In the composition, MEA acts as a crystallization inhibitor, wetting agent and decreases viscosity.

### Example 2—Fire Retardant Composition Comprising Monoguanidine Phosphate and Diguanidine Phosphate

An alternative fire retardant composition according to the present invention comprising monoguanidine phosphate and diguanidine phosphate is given in Table 2 below. The composition is an aqueous solution which can be used for pressure impregnation of wood veneers.

TABLE 2

| component | concentration (wt. %) |
|---|---|
| monoguanidine phosphate | 35.00 |
| diguanidine phosphate | 10.00 |
| urea phosphate | 2.50 |
| monoethanolamine (MEA) | 2.50 |
| water | 50.00 |

### Example 3—Fire Retardant Composition Comprising Ammonium Sulfamate

An alternative fire retardant composition according to the present invention comprising ammonium sulfamate is given in Table 3 below. The composition is an aqueous solution which can be used for impregnation of paper.

TABLE 3

| component | concentration (wt. %) |
|---|---|
| ammonium sulfamate | 34.00 |
| ammonium sulfate | 2.00 |
| carbon spender | 2.00 |
| wetting agent | 1.00 |
| wetting, de-aeration and foam | 3.00 |
| damping agent | |
| monoethanolamine (MEA) | 3.00 |
| water | 55.00 |

### Example 4—Fire Retardant Composition Comprising Monoammonium Phosphate

An alternative fire retardant composition according to the present invention comprising monoammonium phosphate is given in Table 4 below. The composition is an aqueous solution which can be added during production of fiber based products.

TABLE 4

| component | concentration (wt. %) |
|---|---|
| phosphoric acid | 7.30 |
| monoethanolamine | 2.80 |
| water | 32.00 |
| monoammonium phosphate | 45.00 |
| borax pentahydrate | 3.20 |
| dispersing agent | 4.20 |
| foam damping agent | 4.10 |
| wetting agent | 1.40 |

1. A fire retardant composition for natural fiber products, said fire retardant composition comprising one or more fire retardants and monoethanolamine, and wherein said fire retardants have a total concentration of at least 20.00 wt. % based on the total weight of the fire retardant composition, characterized in that, monoethanolamine and said fire retardants are present in the fire retardant composition in a weight ratio of between 1:5 and 1:50.

2. The fire retardant composition according to claim 1, characterized in that, said fire retardants are chosen from the group of phosphorous-based compounds, sulfur-based compounds, boron-based compounds, ammonium-based compounds, guanidine-based compounds, citric acid based compounds, mineral hydroxides, or combinations thereof.

3. The fire retardant composition according to claim 1, characterized in that, said monoethanolamine has a concentration of between 0.05 and 8.50 wt. % based on the total weight of the fire retardant composition.

4. The fire retardant composition according to claim 1, characterized in that, said fire retardants comprise first fire retardants chosen from the group of aluminium trihydrate, ammonium bromide, ammonium chloride, ammonium polyphosphate, ammonium sulfamate, ammonium sulfate, borax pentahydrate, boric acid, citric acid, diammonium phosphate, diguanidine phosphate, disodium octaborate, guanidine sulfamate, magnesium ammonium phosphate, monoammonium phosphate, monoguanidine phosphate, phosphoric acid, potassium citrate, sodium tripolyphosphate, urea phosphate, zinc borate, or combinations thereof.

5. The fire retardant composition according to claim 4, characterized in that, said monoethanolamine and said first fire retardants are present in the fire retardant composition in a weight ratio of between 1:5 and 1:40.

6. The fire retardant composition according to claim 4, characterized in that, said first fire retardants have a concentration of between 20.00 and 75.00 wt. % based on the total weight of the fire retardant composition.

7. The fire retardant composition according to claim 4, characterized in that, said first fire retardants are chosen from the group of ammonium polyphosphate, diammonium phosphate, diguanidine phosphate, monoammonium phosphate, monoguanidine phosphate, phosphoric acid, sodium tripolyphosphate, urea phosphate, magnesium ammonium phosphate, or combinations thereof, wherein said first fire retardants have a total concentration of between 20.00 and 75.00 wt. % based on the total weight of the fire retardant composition.

8. The fire retardant composition according to claim 7, characterized in that, said composition comprises one or more further fire retardants, wherein said further fire retardants are chosen from the group of borax pentahydrate, boric acid, disodium octaborate, zinc borate, or combinations thereof, and wherein said further fire retardants have a total concentration of between 2.50 and 10.00 wt. % based on the total weight of the fire retardant composition.

9. The fire retardant composition according to claim 7, wherein boric acid and borax pentahydrate are present in the fire retardant composition in a weight ratio of between 1:5 and 5:1.

10. The fire retardant composition according to claim 8, characterized in that, said further fire retardants is borax pentahydrate and wherein said first fire retardants are chosen from the group of diammonium phosphate, monoammonium phosphate, phosphoric acid, or combinations thereof.

11. The fire retardant composition according to claim 4, characterized in that, said first fire retardants are chosen from the group of borax pentahydrate, boric acid, disodium octaborate, zinc borate, or combinations thereof, wherein said first fire retardants have a total concentration of between 15.00 and 55.00 wt. % based on the total weight of the fire retardant composition.

12. The fire retardant composition according to claim 1, characterized in that, said fire retardant composition has a dry weight of between 10.0 and 75.0%.

13. Use of the fire retardant composition according to claim 1, for the manufacture of fire resistant wood-based panels, wherein said fire retardant composition is applied to cellulose containing material during the production process of the wood-based panel prior to said cellulose containing material being pressed to a panel in the presence of a resin.

14. Use of the fire retardant composition according to claim 1, for the fire resistant treatment of natural fiber products, wherein said fire retardant composition is applied to said natural fiber products by pressure or atmospheric impregnation.

15. Use of the fire retardant composition according to claim 1, for the fire resistant treatment of natural fiber products, wherein said fire retardant composition is applied as a coating to the surface of said natural fiber products.

16. Use of the fire retardant composition according to claim 1, for the fire resistant treatment of natural fiber products, wherein said fire retardant composition is applied to said natural fiber products by spraying or dipping.

17. A fire retardant natural fiber product comprising a fire retardant composition according to claim 1.

18. The fire retardant natural fiber product according to claim 17, characterized in that, said natural fiber product is a wood-based panel chosen from plywood, densified wood, a medium-density fiberboard (MDF), a high-density fiberboard (HDF), a particle board (PB), an oriented strand board (OSB), laminated timber, parallel strand lumber (PSL), laminated strand lumber (LSL), oriented strand lumber (OSL), glued laminated timber (glulam), laminated veneer lumber (LVL), or combinations thereof.
